(19) United States
(12) Patent Application Publication
(10) Pub. No.: US 2012/0161567 A1
(43) Pub. Date: Jun. 28, 2012

(54) STATOR FOR ELECTRIC ROTATING MACHINE AND METHOD OF MANUFACTURING THE SAME

(75) Inventor: Tetsuya GOROHATA, Anjo-shi (JP)

(73) Assignee: DENSO CORPORATION, Kariya-city (JP)

(21) Appl. No.: 13/338,638

(22) Filed: Dec. 28, 2011

(30) Foreign Application Priority Data
Dec. 28, 2010 (JP) 2010-293628

(51) Int. Cl. H02K 1/00; H02K 15/02

(52) U.S. Cl. 310/187; 29/596

(57) ABSTRACT

A stator includes a stator core and a stator coil formed of electric conductor segments. Each of the electric conductor segments has a pair of in-slot portions, a first end portion, and a pair of second end portions. The in-slot portions are respectively received in corresponding two slots of the stator core. The first end portion extends, on one axial side of the stator core, to connect the in-slot portions. The second end portions extend respectively from the in-slot portions on the other axial side of the stator core. Each of the second end portions includes an oblique part and a distal part. The oblique part extends obliquely with respect to an axial end face of the stator core. Corresponding pairs of the distal parts of the electric conductor segments are joined by welding. The oblique parts of the electric conductor segments have a higher hardness than the in-slot portions.

### CROSS-REFERENCE TO RELATED APPLICATION

This application is based on and claims priority from Japanese Patent Application No. 2010-293628, filed on Dec. 28, 2010, the content of which is hereby incorporated by reference in its entirety into this application.

### BACKGROUND

1. Technical Field

The present invention relates to stators for electric rotating machines that are used in, for example, motor vehicles as electric motors and electric generators, and to methods of manufacturing the stators.

2. Description of Related Art

There are known, for example from Japanese Patent No. 3438570, electric rotating machines which include a stator with a segment-type stator coil.

Specifically, the stator includes an annular stator core and the stator coil mounted on the stator core. The stator core has a plurality of slots that are formed in the radially inner surface of the stator core and spaced from one another in the circumferential direction of the stator core. The stator coil is formed by inserting a plurality of electric conductor segments into the slots of the stator core and joining corresponding pairs of free ends of the electric conductor segments.

More specifically, each of the electric conductor segments is substantially U-shaped to include a pair of straight portions extending parallel to each other and a turn portion that connects ends of the straight portions on the same side. In forming the stator coil, the straight portions are axially inserted, from one axial side of the stator core, respectively into corresponding two of the slots of the stator core; the corresponding two slots are separated from each other by a predetermined pitch (e.g., a predetermined number of the slots). Then, free end parts of the straight portions, which respectively protrude outside of the corresponding slots on the other axial side of the stator core, are bent so as to extend along the circumferential direction of the stator core obliquely at a predetermined angle with respect to the axial end face of the stator core. Thereafter, corresponding pairs of the free ends of the electric conductor segments are joined, for example by welding, resulting in the segment-type stator coil.

With the above formation of the stator coil, however, the protruding heights of coil ends of the stator coil from the corresponding axial end faces of the stator core may become large, thereby making it difficult to minimize the overall axial length of the stator coil. Here, the coil ends denote those parts of the stator coil which are located outside of the slots of the stator core and respectively protrude from the corresponding axial end faces of the stator core.

Further, when the predetermined pitch is large and/or the number of magnetic poles of a rotor of the electric rotating machine is small, the free end parts of the electric conductor segments, which extend along the circumferential direction of the stator core obliquely at the predetermined angle with respect to the axial end face of the stator core, may be flexed, thereby increasing the protruding heights of the coil ends of the stator coil.

### SUMMARY

According to an exemplary embodiment, there is provided a stator for an electric rotating machine which includes a hollow cylindrical stator core and a stator coil. The stator core has a plurality of slots formed therein; the slots are spaced from one another in a circumferential direction of the stator core. The stator coil is formed of a plurality of electric conductor segments mounted on the stator core. Each of the electric conductor segments has a pair of in-slot portions, a first end portion, and a pair of second end portions. The in-slot portions are respectively received in corresponding two of the slots of the stator core. The first end portion is located on one axial side of the stator core and extends to connect the in-slot portions. The second end portions are located on the other axial side of the stator core and respectively extend from the in-slot portions. Each of the second end portions includes an oblique part and a distal part. The oblique part extends, along the circumferential direction of the stator core, obliquely at a predetermined angle with respect to an axial end face of the stator core. The distal part extends from the oblique part. Corresponding pairs of the distal parts of the second end portions of the electric conductor segments are joined to form the stator coil. The oblique parts of the second end portions of the electric conductor segments have a higher hardness than the in-slot portions of the electric conductor segments.

Consequently, with the higher hardness, the oblique parts cannot be easily deformed; thus, they can keep substantially straight in shape. As a result, it is possible to minimize the gap between each adjacent pair of the oblique parts, thereby minimizing the protruding height of the second end portions of the electric conductor segments, i.e., the protruding height of the coil end of the stator coil from the axial end face of the stator core on the other axial side of the stator core.

According to the exemplary embodiment, there is also provided a method of manufacturing a stator for an electric rotating machine. The method includes the steps of: (1) preparing a hollow cylindrical stator core and a plurality of substantially U-shaped electric conductor segments having a substantially rectangular cross section, the stator core having a plurality of slots formed therein, the slots being spaced from one another in a circumferential direction of the stator core, each of the electric conductor segments having a pair of straight portions extending parallel to each other and a turn portion that connects ends of the straight portions on the same side; (2) inserting, from one axial side of the stator core, the straight portions of the electric conductor segments respectively into corresponding ones of the slots of the stator core so that free end parts of the straight portions respectively protrude from the corresponding slots on the other axial side of the stator core; (3) bending each of the free end parts of the straight portions of the electric conductor segments to form an oblique part and a distal part, the oblique part extending, along the circumferential direction of the stator core, obliquely at a predetermined angle with respect to an axial end face of the stator core, the distal part extending from the oblique part; (4) welding each corresponding pair of the distal parts of the electric conductor segments; and (5) insulation-treating the welded distal parts of the electric conductor segments. The method further includes, before the bending step, a step of pressing parts of the electric conductor segments which respectively make up the oblique parts of the electric conductor segments after the bending step, thereby increasing hardness of the parts.

With the above method, since the pressing step is performed before the bending step, the hardness of those parts of the electric conductor segments which respectively make up the oblique parts after the bending step is accordingly increased before the bending step. Consequently, with the increased hardness, it is possible to keep those parts of the electric conductor segments straight in shape in the bending step, thereby minimizing the gap between each adjacent pair of the resultant oblique parts of the electric conductor segments. As a result, it is possible to minimize the protruding height of the coil end of the stator coil from the axial end face of the stator core on the other axial side of the stator core. Moreover, since there is a difference in hardness between those parts of the electric conductor segments which respectively make up the oblique parts and the other parts of the electric conductor segments, it is possible to easily bend the electric conductor segments in the bending step.

### BRIEF DESCRIPTION OF THE DRAWINGS

The present invention will be understood more fully from the detailed description given hereinafter and from the accompanying drawings of one exemplary embodiment, which, however, should not be taken to limit the invention to the specific embodiment but are for the purpose of explanation and understanding only.

In the accompanying drawings:

FIG. 1 is a partially cross-sectional view of an automotive alternator according to an exemplary embodiment;

FIG. 2 is a perspective view of a stator of the alternator;

FIG. 3 is a side view of part of the stator;

FIG. 4 is a partially cross-sectional view of part of the stator;

FIG. 5 is a schematic perspective view illustrating the configuration of electric conductor segments for forming a stator coil of the stator;

FIG. 6 is a schematic perspective view illustrating a process of inserting the electric conductor segments into slots formed in a stator core of the stator;

FIG. 7 is a schematic view illustrating the arrangement of the electric conductor segments at a radially outer layer of a coil end of the stator coil, the coil end being comprised of those end parts of the electric conductor segments which are joined to one another;

FIG. 8 is a perspective view of part of the coil end;

FIG. 9 is a schematic cross-sectional view illustrating the arrangement of the electric conductor segments in the slots of the stator core;

FIG. 10 is a flow chart illustrating a method of manufacturing the stator;

FIG. 11 is a schematic view illustrating a pressing step of the method;

FIGS. 12A and 12B are partially cross-sectional views illustrating the pressing step;

FIG. 13A is a schematic view illustrating the change in cross section of an oblique part of one of the electric conductor segments by the pressing step;

FIG. 13B is a cross-sectional view illustrating the cross-sectional shape of other parts of the electric conductor segment;

FIGS. 14A and 14B are partially cross-sectional views illustrating a pressing step according to modifications of the exemplary embodiment; and

FIG. 15 is a schematic perspective view illustrating the configuration of electric conductor segments according to a modification to the exemplary embodiment.

### DESCRIPTION OF EMBODIMENT

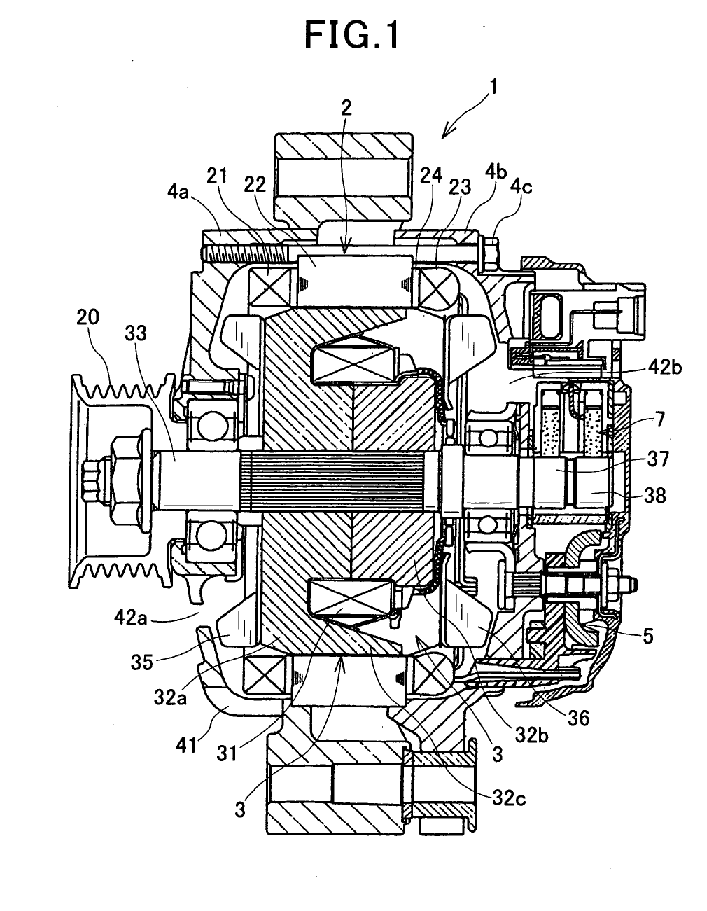

FIG. 1 shows the overall configuration of an automotive alternator 1 according to an exemplary embodiment. The alternator 1 is designed to be used in a motor vehicle, such as a passenger car or a truck.

As shown in FIG. 1, the alternator 1 includes: a stator 2 that functions as an armature; a rotor 3 that functions as a field; a pair of front and rear housings 4a and 4b that are connected and fixed by a plurality of bolts 4c and together accommodate both the stator 2 and the rotor 3; and a rectifier 5 that rectifies three-phase AC power output from the stator 2 into DC power.

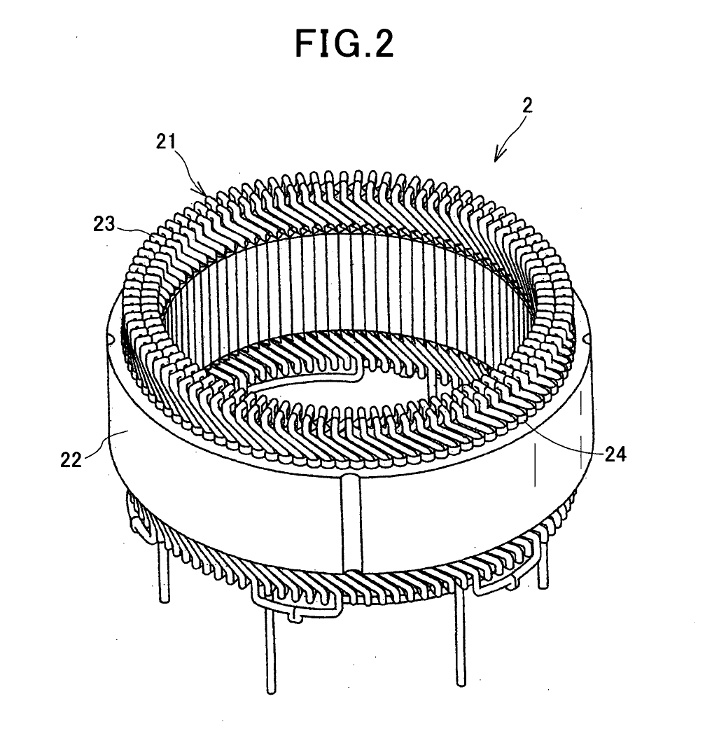

The stator 2 includes, as shown in FIG. 2, a hollow cylindrical stator core 22, a three-phase stator coil 21 mounted on the stator core 22, and an insulator 24 that electrically insulates the stator coil 21 from the stator core 22. Referring back to FIG. 1, the stator 2 is held between the front and rear housings 4a and 4b, so as to surround the rotor 3 with a predetermined radial gap formed between the stator 2 and the rotor 3. The detailed configuration of the stator 2 will be described later.

The rotor 3 includes a rotating shaft 33, a pair of Lundell-type magnetic pole cores 32a and 32b, and a field coil 31. The rotating shaft 33 is rotatably supported by the front and rear housings 4a and 4b. The rotating shaft 33 has a pulley 20 mounted on a front end portion (i.e., a left end portion in FIG. 1) thereof, so that it can be driven by an internal combustion engine (not shown) of the vehicle via the pulley 20. Each of the magnetic pole cores 32a and 32b has a plurality of magnetic pole claws 32c. The field coil 31 is made of, for example, an insulation-treated copper wire and wound into a hollow cylindrical shape. The magnetic pole cores 32a and 32b are fixed on the rotating shaft 33 with the field coil 31 held between the magnetic pole cores 32a and 32b.

In addition, in the present embodiment, the number of the magnetic pole claws 32c of each of the magnetic pole cores 32a and 32b is equal to 8. That is, the rotor 3 has a total of sixteen magnetic poles.

Moreover, the alternator 1 further includes a mixed-flow cooling fan 35, a centrifugal cooling fan 36, a pair of slip rings 37 and 38, and a brush device 7.

The mixed-flow cooling fan 35 is fixed, for example by welding, to a front end face of the magnetic pole core 32a which is located on the front side (i.e., the left side in FIG. 1). The mixed-flow cooling fan 35 sucks cooling air from the front side and discharges the same both in the axial and radial directions of the rotating shaft 33. On the other hand, the centrifugal cooling fan 36 is fixed, for example by welding, to a rear end face of the magnetic pole core 32b which is on the rear side (i.e., the right side in FIG. 1). The centrifugal cooling fan 36 sucks cooling air from the rear side and discharges the same in the radial direction of the rotating shaft 33.

In addition, in a front end wall of the front housing 4a, there are formed a plurality of cooling air suction openings 42a via which the cooling air is sucked into the alternator 1 by the mixed-flow cooling fan 35. On the other hand, in a rear end wall of the rear housing 4b, there are formed a plurality of cooling air suction openings 42b via which the cooling air is sucked into the alternator 1 by the centrifugal cooling fan 36. Moreover, in side walls of the front and rear housings 4a and 4b, there are formed a plurality of cooling air discharge openings 41 via which the cooling air is discharged out of the alternator 1 by the mixed-flow and centrifugal cooling fans 35 and 36. Further, in the present embodiment, the cooling air discharge openings 41 are formed in the front and rear housings 4a and 4b so as to face those parts of the stator coil 21 which protrude from the axial end faces of the stator core 22.

The slip rings 37 and 38 are provided on a rear end portion (i.e., a right end portion in FIG. 1) of the rotating shaft 33 and respectively electrically connected to opposite ends of the field coil 31.

The brush device 7 includes a pair of brushes that are respectively arranged on the radially outer peripheries of the slip rings 37 and 38, so as to supply field current to the field coil 31 via the slip rings 37 and 38.

The automotive alternator 1 having the above-described configuration operates in the following way. When torque is transmitted from the engine to the pulley 20 via, for example, a belt (not shown), the rotor 3 is driven by the torque to rotate in a predetermined direction. During the rotation of the rotor 3, the field current is supplied to the field coil 31 through sliding contact between the slip rings 37 and 38 and the brushes of the brush device 7, thereby magnetizing the magnetic pole claws 32c of the magnetic pole cores 32a and 32b to create a rotating magnetic field. The rotating magnetic field induces the three-phase AC power in the stator coil 21. Then, the rectifier 5 rectifies the three-phase AC power output from the stator coil 21 into the DC power and outputs the obtained DC power via output terminals thereof.

After having described the overall configuration and operation of the alternator 1, the detailed configuration of the stator 2 of the alternator 1 will be described with reference to FIGS. 2-9.

In the stator core 22, there are formed a plurality of slots 25 for receiving the stator coil 21. As shown in FIG. 4, each of the slots 25 has a substantially rectangular cross section. In the present embodiment, there are provided two slots 25 per magnetic pole of the rotor 3 that has the sixteen magnetic poles and per phase of the three-phase stator coil 21. Accordingly, the total number of the slots 25 formed in the stator core 22 is equal to 96 (i.e., 2×16×3).

The stator coil 21 is formed by mounting a plurality of substantially U-shaped electric conductor segments 23 to the stator core 22 and joining corresponding pairs of free ends of the electric conductor segments 23. That is, the stator coil 21 is a segment-type stator coil. In addition, in the present embodiment, each of the electric conductor segments 23 has an insulating coat (not shown) covering its outer surface.

Specifically, before being mounted to the stator core 22, each of the electric conductor segments 23 has, as shown in FIG. 6, a pair of straight portions 23g extending parallel to each other and a turn portion 23h that connects ends of the straight portions 23g on the same side. In forming the stator coil 21, the straight portions 23g are axially inserted, from one axial side of the stator core 22, respectively into corresponding two of the slots 25 of the stator core 22; the corresponding two slots 25 are separated from each other by a predetermined pitch. Then, free end parts of the straight portions 23g, which respectively protrude outside of the corresponding slots 25 on the other axial side of the stator core 22, are bent so as to extend along the circumferential direction of the stator core 22 obliquely at a predetermined angle with respect to the axial end face of the stator core 22. Thereafter, corresponding pairs of the free ends of the electric conductor segments 23 are joined by, for example, welding.

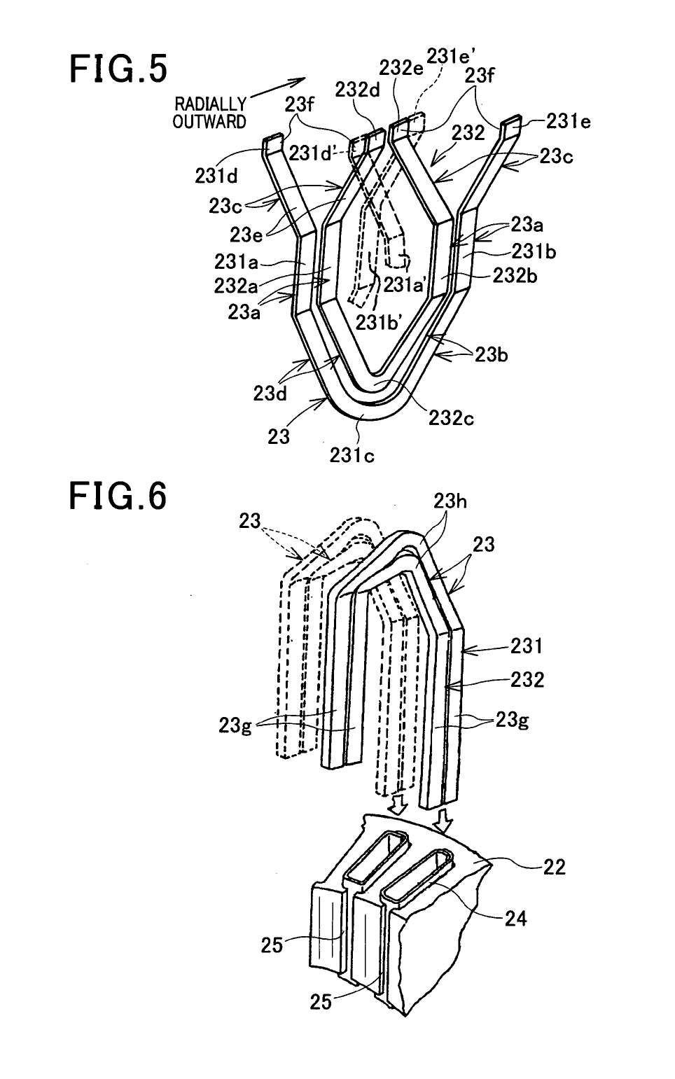

Consequently, in the resultant stator coil 21, each of the electric conductor segments 23 has, as shown in FIG. 5, a pair of in-slot portions 23a, a first end portion 23b, and a pair of second end portions 23c. The in-slot portions 23a are respectively received in the corresponding two slots 25 of the stator core 22 and extend in the axial direction of the stator core 22. The first end portion 23b, which corresponds to the turn portion 23h before the mounting of the electric conductor segment 23 to the stator core 22, connects the in-slot portions 23a on the one axial side (i.e., the rear side of the alternator 1 or the right side in FIG. 1) of the stator core 22. The second end portions 23c, which correspond to the free end parts of the straight portions 23g before the mounting of the electric conductor segment 23 to the stator core 22, respectively extend from the in-slot portions 23a on the other axial side (i.e., the front side of the alternator 1 or the left side in FIG. 1) of the stator core 22.

Moreover, the first end portion 23b includes, at the tip thereof, a bent part 23d that is substantially V-shaped. On the other hand, each of the second end portions 23c is bent twice to include an oblique part 23e and a distal part 23f. The oblique part 23e extends, along the circumferential direction of the stator core 22, obliquely at the predetermined angle with respect to the axial end face of the stator core 22 on the other axial side of the stator core 22.

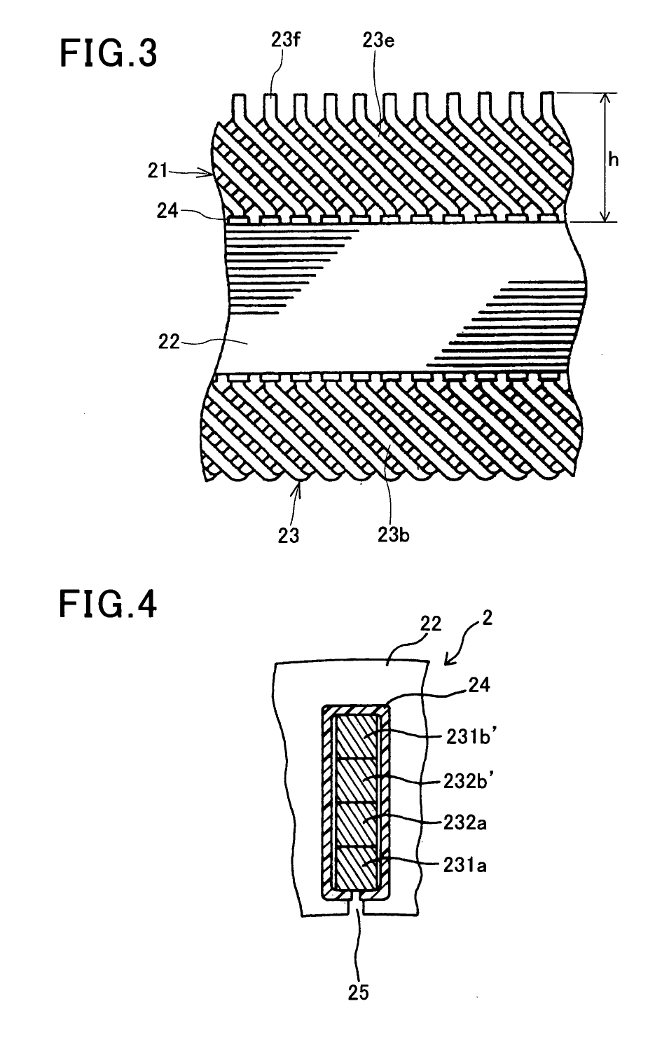

In the present embodiment, the oblique parts 23e of the second end portions 23c of the electric conductor segments 23 are pressed to have a higher hardness than the in-slot portions 23a of the electric conductor segments 23. Consequently, the oblique parts 23e cannot be easily deformed, thus keeping substantially straight in shape. As a result, it is possible to minimize the gap between each adjacent pair of the oblique parts 23e of the electric conductor segments 23, thereby minimizing the protruding height h of the second end portions 23c of the electric conductor segments 23, i.e., the protruding height h of the coil end of the stator coil 21 from the axial end face of the stator core 22 on the other axial side of the stator core 22 (see FIG. 3).

In each of the slots 25 of the stator core 22, there are received an even number of electric conductors (i.e., the in-slot portions 23a of the electric conductor segments 23).

More specifically, in the present embodiment, as shown in FIG. 4, in each of the slots 25 of the stator core 22, there are received four electrical conductors that are aligned in the radial direction of the stator core 22. Hereinafter, the four electrical conductors are sequentially referred to as an inside conductor, an inside-center conductor, an outside-center conductor, and an outside conductor from the radially inside to the radially outside of the slot 25. In addition, all of the four electric conductors received in the same slot 25 belong to the same phase of the stator coil 21.

Moreover, the electric conductors received in the slots 25 of the stator core 22 are electrically connected to one another in a predetermined pattern, forming the stator coil 21.

In the present embodiment, the electric conductors received in the slots 25 of the stator core 22 are made up of the in-slot portions 23a of the electric conductor segments 23. On the one axial side of the stator core 22, the electric conductors received in the slots 25 of the stator core 22 are electrically connected to one another via the first end portions 23b of the electric conductor segments 23. On the other axial side of the stator core 22, the electric conductors received in the slots 25 of the stator core 22 are electrically connected to one another by joining corresponding pairs of the distal parts 23f of the electric conductor segments 23. The first end portions 23b of the electric conductor segments 23 together make up the coil end of the stator coil 21 on the one axial side of the stator core 22. The second end portions 23c of the electric conductor segments 23 together make up the coil end of the stator coil 21 on the other axial side of the stator core 22.

Moreover, in the present embodiment, each electrically connected pair of the electric conductors are respectively received in a pair of the slots 25 of the stator core 22 which are separated from each other by a predetermined pitch.

For example, referring to FIGS. 5 and 9, for one of the slots 25, the inside conductor 231a in the slot 25 is electrically connected, via a connecting conductor 231c, to the outside conductor 231b in another one of the slots 25 which is positioned away from the slot 25 by one magnetic pole pitch in the clockwise direction; the connecting conductor 231c is located on the one axial side of the stator core 22.

Similarly, for one of the slots 25, the inside-center conductor 232a in the slot 25 is connected, via a connecting conductor 232c, to the outside-center conductor 232b in another one of the slots 25 which is positioned away from the slot 25 by one magnetic pole pitch in the clockwise direction; the connecting conductor 232c is also located on the one axial side of the stator core 22.

Consequently, on the one axial side of the stator core 22, each of the connecting conductors 232c that respectively connect pairs of the inside-center conductors 232a and the outside-center conductors 232b is covered by a corresponding one of the connecting conductors 231c that respectively connect pairs of the inside conductors 231a and the outside conductors 231b. As a result, all the connecting conductors 232c together form an axially inner layer of the coil end of the stator coil 21 on the one axial side of the stator core 22; all the connecting conductors 231c together form an axially outer layer of the coil end of the stator coil 21 on the one axial side of the stator core 22.

Moreover, for one of the slots 25, the inside-center conductor 232a in the slot 25 is electrically connected, on the other axial side of the stator core 22, to the inside conductor 231′a in another one of the slots 25 which is positioned away from the slot 25 by one magnetic pole pitch in the clockwise direction. More specifically, the inside-center conductor 232a is electrically connected to the inside conductor 231′a by joining a pair of connecting conductors 232d and 231d′ that respectively extend from the inside-center conductor 232a and the inside conductor 231a′.

Similarly, for one of the slots 25, the outside conductor 231b′ in the slot 25 is electrically connected, on the other axial side of the stator core 22, to the outside-center conductor 232b in another one of the slots 25 which is positioned away from the slot 25 by one magnetic pole pitch in the clockwise direction. More specifically, the outside conductor 231b′ is electrically connected to the outside-center conductor 232b by joining a pair of connecting conductors 231e′ and 232e that respectively extend from the outside conductor 231b′ and the outside-center conductor 232b.

Consequently, on the other axial side of the stator core 22, each of the joints between the connecting conductors 232d and the connecting conductors 231d′ is positioned away from a corresponding one of the joints between the connecting conductor 231e′ and the connecting conductors 232e both in the radial and circumferential directions of the stator core 22. As a result, as shown in FIG. 8, all the joints between the connecting conductors 232d and the connecting conductors 231d′ fall on the same circle to form a radially inner layer of the coil end of the stator coil 21 on the other axial side of the stator core 22; all the joints between the connecting conductor 231e′ and the connecting conductors 232e fall on the same circle to form a radially outer layer of the coil end of the stator coil 21 on the other axial side of the stator core 22. In addition, to electrically insulate the joints between the connecting conductors 232d and the connecting conductors 231d′ from the joints between the connecting conductor 231e′ and the connecting conductors 232e, an insulating material is coated on all the joints.

Moreover, in the present embodiment, as shown in FIGS. 5 and 6, the electric conductor segments 23 are comprised of a plurality of pairs of first and second electric conductor segments 231 and 232. Each connected set of the inside conductor 231a, outside conductor 231b, and connecting conductors 231c, 231d and 231e is formed in once piece construction by using one of the first electric conductor segments 231. On the other hand, each connected set of the inside-center conductor 232a, outside-center conductor 232b, and connecting conductors 232c and 232d and 232e is formed in one piece construction by using one of the second electric conductor segments 232.

In the present embodiment, the three-phase stator coil 21 is comprised of phase windings that are star-connected. Each of the phase windings is formed of a predetermined number of the electric conductor segments 23 and extends around the stator core 22 by two turns. In addition, it should be noted that electric conductor segments that are different from the above-described electric conductor segments 23 are also used for the formation of the stator coil 21. Those electric conductor segments include, for example, electric conductor segments for forming output and neutral terminals of the phase windings of the stator coil 21 and electric conductor segments for connecting different turns of the same phase winding.

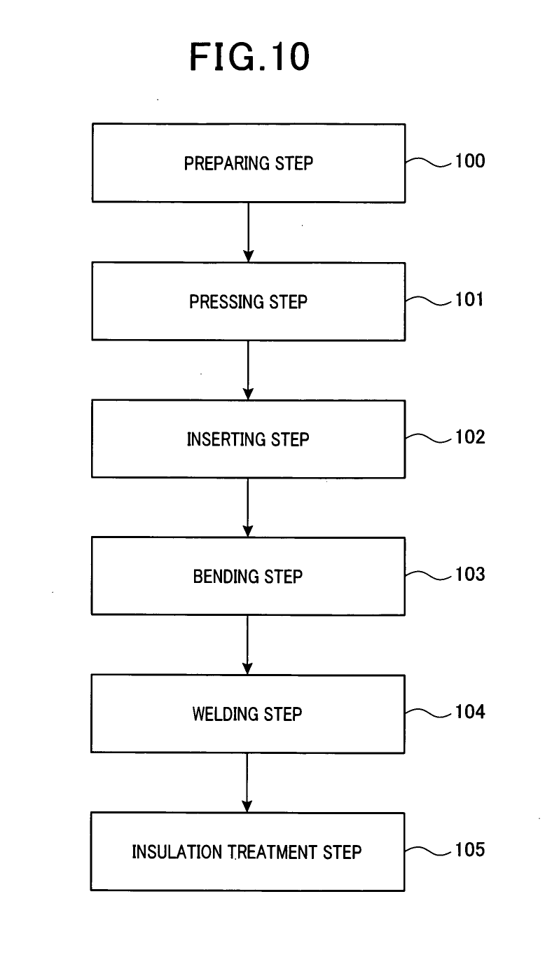

Next, a method of manufacturing the stator 2 according to the present embodiment will be described with reference to FIGS. 10-13B.

As shown in FIG. 10, the method according to the present embodiment includes a preparing step 100, a pressing step 101, an inserting step 102, a bending step 103, a welding step 104, and an insulation treatment step 105.

In the preparing step 100, the hollow cylindrical stator core 22 and the substantially U-shaped electric conductor segments 23 as shown in FIG. 6 are prepared.

In the pressing step 101, for each of the electric conductor segments 23, parts of the electric conductor segment 23, which will make up the oblique parts 23e of the electric conductor segment 23 after the bending step 103, are pressed and thereby hardened.

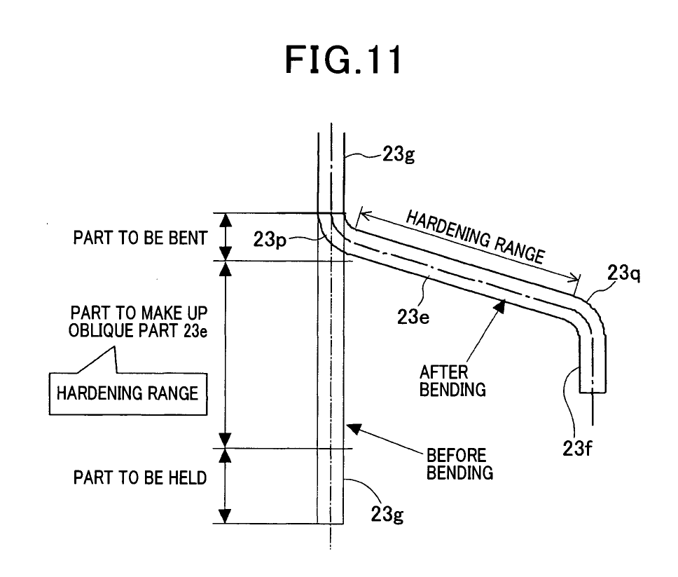

FIG. 11 illustrates one of those parts. As shown in the figure, the part to make up an oblique part 23e is positioned between a part of the electric conductor segment 23 which will be bent in the bending step 103 and a part of the same which will be held in the pressing step 101.

In addition, it should be noted that the oblique part 23e does not include a pair of bent parts 23p and 23q which are formed, in the bending step 103, respectively on opposite sides of the oblique part 23e.

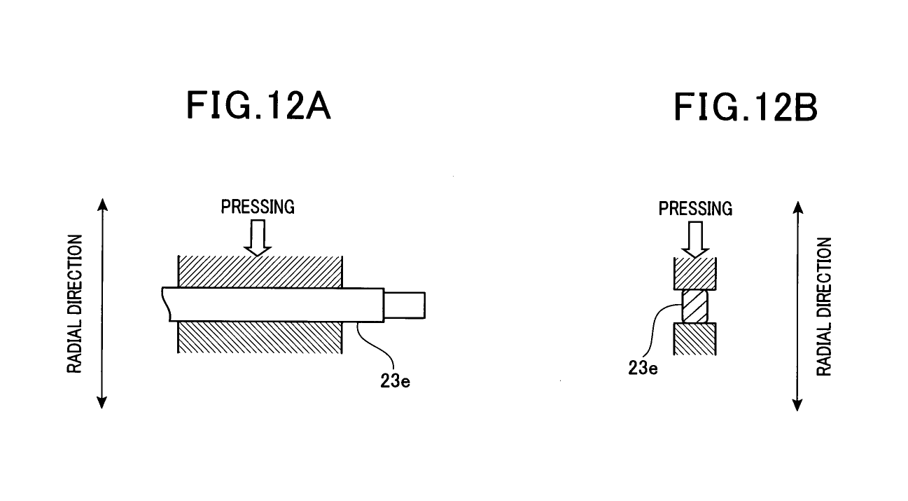

As shown in FIGS. 12A and 12B, in the pressing step 101, the part to make up the oblique part 23e is placed and pressed between a die 51 and a punch 52.

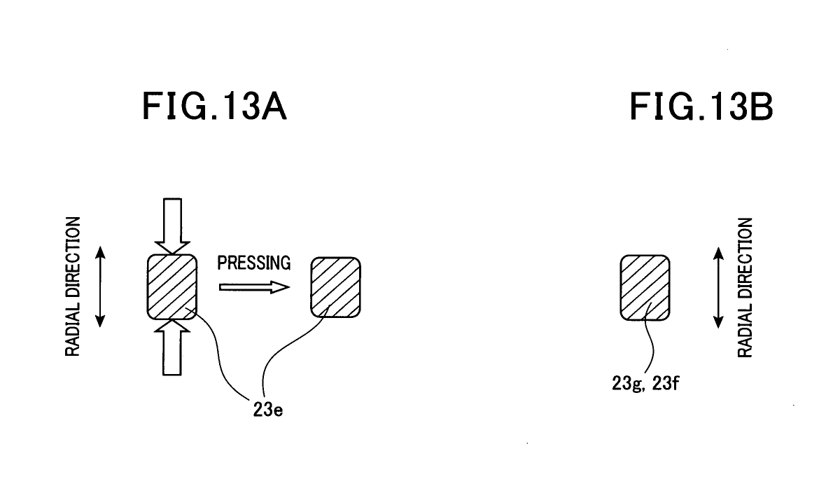

More specifically, as shown in FIG. 13A, in the present embodiment, those side faces of the part which will respectively make up a radially-opposite pair of side faces of the oblique part 23e are pressed in the pressing step 101.

Consequently, the hardness of the part to make up the oblique part 23e is increased to become higher than the hardness of other parts of the electric conductor segment 23.

Moreover, as shown in FIGS. 13A and 13B, the radial width of the part to make up the oblique part 23e is reduced to become smaller than the radial width of other parts of the electric conductor segment 23. However, the cross-sectional area of the part to make up the oblique part 23e is kept constant (or unchanged) before and after the pressing step 101.

In addition, it is preferable that on the pressing surfaces of the die 51 and the punch 52, there is formed a pattern including micro protrusions and recesses, such as a grain pattern. In this case, it is possible to lower the pressing load in pressing the oblique parts 23e, thereby preventing damage of the insulating coat that covers the outer surfaces of the oblique parts 23e.

In the inserting step 102, for each of the electric conductor segments 23, the straight portions 23g of the electric conductor segment 23 are axially inserted, from the one axial side of the stator core 22, respectively into the corresponding two slots 25 of the stator core 22 which are separated from each other by one magnetic pole pitch. Consequently, the free end parts of the straight portions 23g respectively protrude outside of the corresponding two slots 25 on the other axial side of the stator core 22.

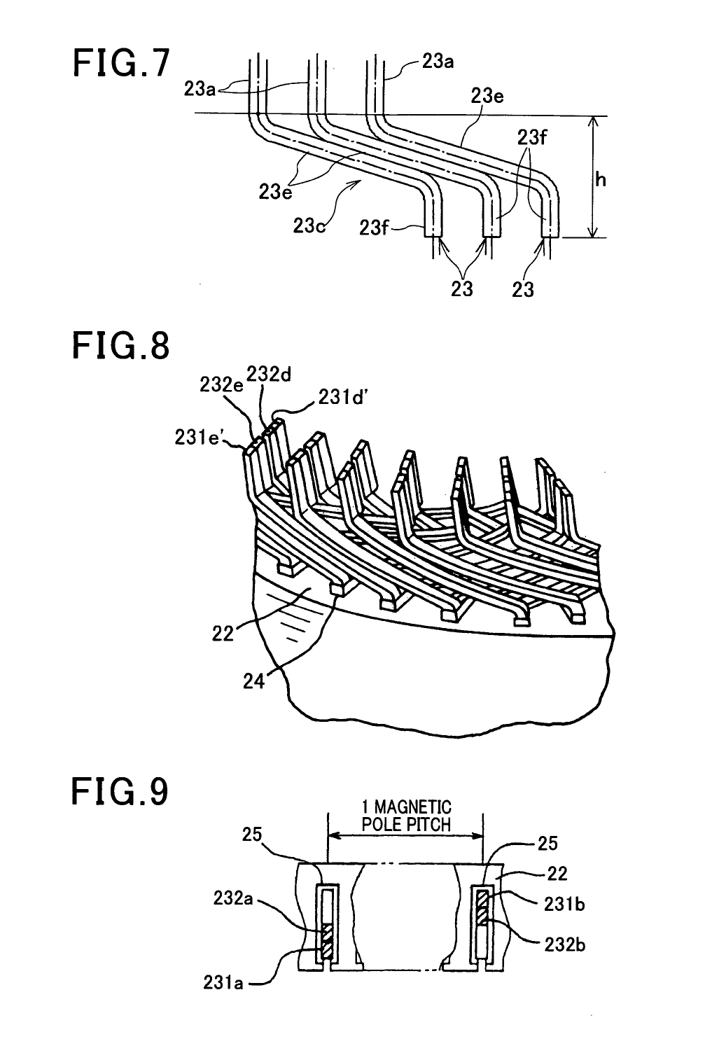

In the bending step 103, for each of the straight portions 23g of the electric conductor segments 23, the free end part of the straight portion 23g is bent twice to form the oblique part 23e and the distal part 23f as shown in FIGS. 5 and 7. The oblique part 23e extends, along the circumferential direction of the stator core 22, obliquely at the predetermined angle with respect to the axial end face of the stator core 22 on the other axial side of the stator core 22. The distal part 23f extends, from the oblique part 23e, in the axial direction of the stator core 22.

In addition, in the bending step 103, it is easy for springback of the electric conductor segments 23 to occur, causing the distal parts 23f of the electric conductor segments 23 to be out of alignment with each other. Therefore, it is preferable for the method to further include, after the bending step 103 and before the welding step 104, a step of aligning the distal parts 23f of the electric conductor segments 23.

In the welding step 104, corresponding pairs of the distal parts 23f of the electric conductor segments 23 are welded.

Specifically, in the present embodiment, for each corresponding pair of the distal end parts 23f of the electric conductor segments 23, an earth electrode is first mounted to the pair of the distal end parts 23f, thereby fixing them with the earth electrode. Next, a welding electrode is moved downward to a position where the welding electrode faces the pair of the distal end parts 23f through an air gap formed therebetween. Then, an electric arc is discharged from the welding electrode to the pair of the distal parts 23f, thereby melting and mixing together the metals of the pair of the distal parts 23f. Consequently, a weld (or joint) is formed between the pair of the distal parts 23f, thereby joining them together. Thereafter, the earth and welding electrodes are removed from the pair of the distal parts 23f.

In the insulation treatment step 105, a powder resin is first applied onto the distal end parts 23f of the electric conductor segments 23 and the welds formed between the distal end parts 23f. Next, the powder resin is melted by heat and then solidified, thereby forming an insulating layer that electrically insulates the welds from each other.

As a result, the stator 2 according to the present embodiment is obtained.

According to the present embodiment, it is possible to achieve the following advantages.

In the present embodiment, the stator 2 includes the hollow cylindrical stator core 22 and the stator coil 21. The stator core 22 has the slots 25 formed therein. The slots 25 are spaced from one another in the circumferential direction of the stator core 22. The stator coil 21 is formed of the electric conductor segments 23 mounted on the stator core 22. Each of the electric conductor segments 23 has the pair of in-slot portions 23a, the first end portion 23b, and the pair of second end portions 23c. The in-slot portions 23a are respectively received in the corresponding two slots 25 of the stator core 22. The first end portion 23b is located on the one axial side of the stator core 22 and extends to connect the in-slot portions 23a. The second end portions 23c are located on the other axial side of the stator core 22 and respectively extend from the in-slot portions 23a. Each of the second end portions 23c includes the oblique part 23e and the distal part 23f. The oblique part 23e extends, along the circumferential direction of the stator core 22, obliquely at the predetermined angle with respect to the axial end face of the stator core 22. The distal part 23f extends from the oblique part 23e. Corresponding pairs of the distal parts 23f of the second end portions 23c of the electric conductor segments 23 are joined, for example by arc welding, to form the stator coil 21. The oblique parts 23e of the second end portions 23c of the electric conductor segments 23 have the higher hardness than the in-slot portions 23a of the electric conductor segments 23.

Consequently, with the higher hardness, the oblique parts 23e cannot be easily deformed; thus, they can keep substantially straight in shape. As a result, it is possible to minimize the gap between each adjacent pair of the oblique parts 23e, thereby minimizing the protruding height h of the second end portions 23c of the electric conductor segments 23, i.e., the protruding height h of the coil end of the stator coil 21 from the axial end face of the stator core 22 on the other axial side of the stator core 22.

In the present embodiment, the higher hardness of the oblique parts 23e of the second end portions 23c of the electric conductor segments 23 is obtained by pressing the oblique parts 23e.

Consequently, it is possible to easily increase the hardness of the oblique parts 23e.

In the present embodiment, for each of the oblique parts 23e of the second end portions 23c of the electric conductor segments 23, the cross-sectional area of the oblique part 23e is kept constant before and after the pressing of the oblique part 23e.

Consequently, it is possible to prevent the electric resistance of the oblique part 23e from increasing due to the pressing of the oblique part 23e. In the present embodiment, for each of the oblique parts 23e of the second end portions 23c of the electric conductor segments 23, the pair of side faces of the oblique part 23e which are opposite to each other in the radial direction of the stator core 22 are pressed in the pressing of the oblique part 23e.

Consequently, it is possible to reduce the radial width of the oblique parts 23e of the second end portions 23c of the electric conductor segments 23.

Further, in the present embodiment, the radial width of the oblique parts 23e of the second end portions 23c of the electric conductor segments 23 is reduced to become smaller than the radial width of the in-slot portions 23a of the electric conductor segments 23 (see FIGS. 13A and 13B).

Consequently, it is possible to minimize both the radial width and outer diameter of the coil end of the stator coil 21 on the other axial side of the stator core 22.

In the present embodiment, for each of the oblique parts 23e of the second end portions 23c of the electric conductor segments 23, the pressing of the oblique part 23e is performed over the entire length of the oblique part 23e.

Consequently, the hardness of the oblique part 23e can be uniformly increased over the entire length thereof.

In the present embodiment, the method of manufacturing the stator 2 includes the preparing step 100, the inserting step 102, the bending step 103, the welding step 104, and the insulation treatment step 105. In the preparing step 100, the hollow cylindrical stator core 22 and the substantially U-shaped electric conductor segments 23 are prepared. Each of the electric conductor segments 23 has, as shown in FIG. 6, the straight portions 23g extending parallel to each other and the turn portion 23h that connects ends of the straight portions 23g on the same side. In the inserting step 102, the straight portions 23g of the electric conductor segments 23 are inserted, from the one axial side of the stator core 22, respectively into the corresponding slots 25 of the stator core 22. Consequently, the free end parts of the straight portions 23g respectively protrude from the corresponding slots 25 on the other axial side of the stator core 22. In the bending step 103, each of the free end parts of the straight portions 23g of the electric conductor segments 23 is bent twice to form the oblique part 23e and the distal part 23f as shown in FIG. 7. In the welding step 104, each corresponding pair of the distal parts 23f of the electric conductor segments 23 is welded. In the insulation treatment step 105, the welded pairs of the distal parts 23f of the electric conductor segments 23 are insulation-treated. Moreover, in the present embodiment, the method of manufacturing the stator 2 further includes the pressing step 101 that is performed no later than the bending step 103. In the pressing step 101, those parts of the electric conductor segments 23 which respectively make up the oblique parts 23e after the bending step 103 are pressed, thereby increasing the hardness of those parts.

With the above method, since the pressing step 101 is performed no later than the bending step 103, the hardness of those parts of the electric conductor segments 23 which respectively make up the oblique parts 23e after the bending step 103 is accordingly increased before the bending step 103. Consequently, with the increased hardness, it is possible to keep those parts of the electric conductor segments 23 straight in shape in the bending step 103, thereby minimizing the gap between each adjacent pair of the resultant oblique parts 23e of the electric conductor segments 23. As a result, it is possible to minimize the protruding height h of the coil end of the stator coil 21 from the axial end face of the stator core 22 on the other axial side of the stator core 22. Moreover, since there is a difference in hardness between those parts of the electric conductor segments 23 which respectively make up the oblique parts 23e and the other parts of the electric conductor segments 23, it is possible to easily bend the electric conductor segments 23 in the bending step 103.

Further, in the present embodiment, the pressing step 101 is performed before the inserting step 102. Consequently, in the pressing step 101, it is possible to press the electric conductor segments 23 severally, thereby facilitating the pressing of the electric conductor segments 23.

While the above particular embodiment has been shown and described, it will be understood by those skilled in the art that various modifications, changes, and improvements may be made without departing from the spirit of the invention.

For example, in the previous embodiment, for each of the oblique parts 23e of the electric conductor segments 23, the pair of side faces of the oblique part 23e which are opposite to each other in the radial direction of the stator core 22 are pressed in the pressing step 101, without constraining the other pair of side faces of the oblique part 23e.

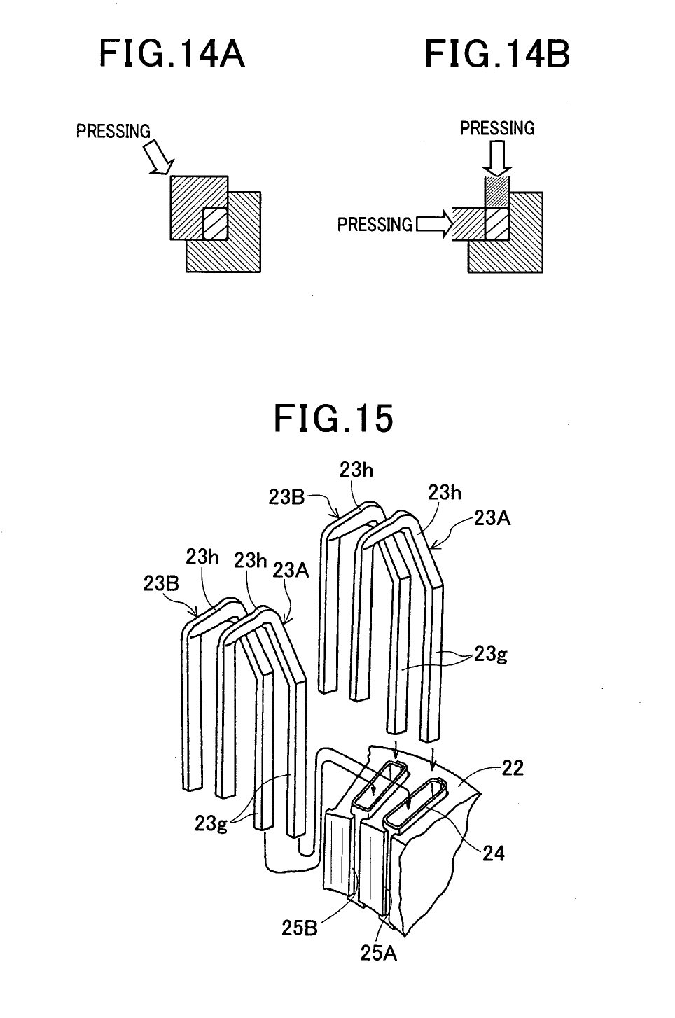

However, as shown in FIGS. 14A and 14B, it is also possible to press the oblique part 23e with all of the four side faces of the oblique part 23e constrained. In this case, the pressing force can be easily applied to the oblique part 23e, thereby reliably increasing the hardness of the oblique part 23e.

In addition, the pressing force can be applied to the oblique part 23e in a diagonal direction as shown FIG. 14A, or both in the vertical and horizontal directions as shown in FIG. 14B.

In the previous embodiment, the pressing step 101 is performed before the inserting step 102. However, the pressing step 101 may also be performed after the inserting step 102 and before the bending step 103. In this case, it is possible to press a plurality of the oblique parts 23e of the electric conductor segments 23 at the same time, thereby improving the productivity.

In the previous embodiment, as shown in FIGS. 5 and 6, the electric conductor segments 23 are comprised of the plurality of pairs of first and second electric conductor segments 231 and 232, the first electric conductor segments 231 being different in shape from the second electric conductor segments 232.

However, as shown in FIG. 15, the electric conductor segments 23 may also be comprised of a plurality of pairs of electric conductor segments 23A and 23B, the electric conductor segments 23A being identical in shape to the electric conductor segments 23B. More specifically, in this case, for each pair of the electric conductor segments 23A and 23B, the straight portions 23g of the electric conductor segment 23A are respectively received in a pair of the slots 25 which are respectively adjacent to another pair of the slots 25 in which the straight portions 23g of the electric conductor segments 23B are respectively received.

For example, for the right-side pair of the electric conductor segments 23A and 23B in FIG. 15, one of the straight portions 23g of the electric conductor segment 23A is received at the outside layer in the slot 25A; the other straight portion 23g of the electric conductor segment 23A is received at the outside-center layer in another slot 25 (not shown) that is positioned away from the slot 25A by one magnetic pole pitch in the counterclockwise direction. On the other hand, one of the straight portions 23g of the electric conductor segment 23B is received at the outside layer in the slot 25B that is adjacent to the slot 25A; the other straight portion 23g of the electric conductor segment 23B is received at the outside-center layer in another slot 25 (not shown) that is positioned away from the slot 25B by one magnetic pole pitch in the counterclockwise direction. That is, the slots 25 in which the straight portions 23g of the electric conductor segment 23A are respectively received are offset, in the circumferential direction of the stator core 22, by one slot pitch from those in which the straight portions 23g of the electric conductor segment 23B are respectively received.

With the above arrangement, the turn portions 23g of the electric conductor segments 23A and 23B do not intersect at the centers thereof. Consequently, it is possible to minimize the protruding height of the turn portions 23h from the axial end face of the stator core 22 on the one axial side of the stator core 22.

In addition, in the above case, in each of the slots 25 of the stator core 22, there are also received an even number (e.g., four) of the straight portions 23g of the electric conductor segments 23A and 23B as in the previous embodiment. Moreover, though not shown in FIG. 15, each of the free end parts of the straight portions 23g of the electric conductor segments 23A and 23B is bent, on the other axial side of the stator core 22, to form an oblique part 23e and a distal part 23f. Corresponding pairs of the distal parts 23f of the electric conductor segments 23A and 23B are welded to form the stator coil 21.

In the previous embodiment, the present invention is directed to the stator 2 of the automotive alternator 1. However, the invention can also be applied to stators of other electric rotating machines, for example, a stator of a motor-generator used in a hybrid vehicle.

What is claimed is:

1. A stator for an electric rotating machine, the stator comprising:
a hollow cylindrical stator core having a plurality of slots formed therein, the slots being spaced from one another in a circumferential direction of the stator core; and
a stator coil formed of a plurality of electric conductor segments mounted on the stator core, each of the electric conductor segments having a pair of in-slot portions, a first end portion, and a pair of second end portions, the in-slot portions being respectively received in corresponding two of the slots of the stator core, the first end portion being located on one axial side of the stator core and extending to connect the in-slot portions, the second end portions being located on the other axial side of the stator core and respectively extending from the in-slot portions, each of the second end portions including an oblique part and a distal part, the oblique part extending, along the circumferential direction of the stator core, obliquely at a predetermined angle with respect to an axial end face of the stator core, the distal part extending from the oblique part,
wherein
corresponding pairs of the distal parts of the second end portions of the electric conductor segments are joined to form the stator coil, and
the oblique parts of the second end portions of the electric conductor segments have a higher hardness than the in-slot portions of the electric conductor segments.

2. The stator as set forth in claim 1, wherein the higher hardness of the oblique parts of the second end portions of the electric conductor segments is obtained by pressing the oblique parts.

3. The stator as set forth in claim 2, wherein for each of the oblique parts of the second end portions of the electric conductor segments, a cross-sectional area of the oblique part is kept constant before and after the pressing of the oblique part.

4. The stator as set forth in claim 2, wherein each of the electric conductor segments has a substantially rectangular cross section, and
for each of the oblique parts of the second end portions of the electric conductor segments, the pressing of the oblique part is performed with four side faces of the oblique part constrained.

5. The stator as set forth in claim 2, wherein each of the electric conductor segments has a substantially rectangular cross section, and
for each of the oblique parts of the second end portions of the electric conductor segments, a pair of side faces of the oblique part which are opposite to each other in a radial direction of the stator core are pressed in the pressing of the oblique part.

6. The stator as set forth in claim 5, wherein the oblique parts of the second end portions of the electric conductor segments have a smaller radial width than the in-slot portions of the electric conductor segments.

7. The stator as set forth in claim 2, wherein for each of the oblique parts of the second end portions of the electric conductor segments, the pressing of the oblique part is performed over an entire length of the oblique part.

8. A method of manufacturing a stator for an electric rotating machine, the method comprising the steps of:
preparing a hollow cylindrical stator core and a plurality of substantially U-shaped electric conductor segments having a substantially rectangular cross section, the stator core having a plurality of slots formed therein, the slots being spaced from one another in a circumferential direction of the stator core, each of the electric conductor segments having a pair of straight portions extending parallel to each other and a turn portion that connects ends of the straight portions on the same side;
inserting, from one axial side of the stator core, the straight portions of the electric conductor segments respectively into corresponding ones of the slots of the stator core so that free end parts of the straight portions respectively protrude from the corresponding slots on the other axial side of the stator core;
bending each of the free end parts of the straight portions of the electric conductor segments to form an oblique part and a distal part, the oblique part extending, along the circumferential direction of the stator core, obliquely at a predetermined angle with respect to an axial end face of the stator core, the distal part extending from the oblique part;
welding each corresponding pair of the distal parts of the electric conductor segments; and
insulation-treating the welded distal parts of the electric conductor segments,
wherein
the method further comprises, before the bending step, a step of pressing parts of the electric conductor segments which respectively make up the oblique parts of the electric conductor segments after the bending step, thereby increasing hardness of the parts.

9. The method as set forth in claim 8, wherein the pressing step is performed before the inserting step.

10. The method as set forth in claim 8, wherein the pressing step is performed after the inserting step.

11. The method as set forth in claim 8, wherein for each of the oblique parts of the electric conductor segments, a cross-sectional area of the oblique part is kept constant before and after the pressing step.

12. The method as set forth in claim 8, wherein for each of the oblique parts of the electric conductor segments, the pressing step is performed with four side faces of the oblique part constrained.

13. The method as set forth in claim 8, wherein for each of the oblique parts of the electric conductor segments, a pair of side faces of the oblique part which are opposite to each other in a radial direction of the stator core are pressed in the pressing step.
